(19) United States
(12) Patent Application Publication
(10) Pub. No.: US 2013/0301996 A1
(43) Pub. Date: Nov. 14, 2013

(54) OPTICAL FIBER CONNECTING ASSEMBLY AND OPTICAL-ELECTRICAL CONVERSION MODULE THEREOF

(71) Applicant: KUO-FONG TSENG, Tu-Cheng (TW)

(72) Inventor: KUO-FONG TSENG, Tu-Cheng (TW)

(21) Appl. No.: 13/651,647

(22) Filed: Oct. 15, 2012

(30) Foreign Application Priority Data
May 11, 2012 (TW) 101116986

(51) Int. Cl. G02B 6/42

(52) U.S. Cl. 385/89

(57) ABSTRACT

An optical fiber connecting assembly includes two optical-electrical conversion modules and a plurality of optical fibers for connecting with the optical-electrical conversion modules. The optical-electrical conversion module includes a circuit board, an optical signal receiving member and an optical signal emitting member mounted on the circuit board, a cover, and several lenses. The cover covers the optical signal receiving member and the optical signal emitting member, and is fixed with the circuit board with glue. A connecting surface of the cover facing towards the circuit board defines a glue-overflow hole, for receiving excessive glue. The first lenses are mounted on the cover, and couple with the optical signal receiving member and the optical signal emitting member, respectively. Each end of the optical fibers inserted into the cover and couple with the first lenses of one corresponding optical-electrical conversion module. The present disclosure further includes an optical-electrical conversion module thereof.

### BACKGROUND

1. Technical Field

The present disclosure relates to optical fiber connecting assemblies, particularly to an optical fiber connecting assembly and an optical-electrical conversion module of the optical fiber connecting assembly.

2. Description of Related Art

Optical communication is popular due to its high speed and large data carrying capacity. Optical fiber connectors, for transmitting optical signals, include at least one optical-electrical conversion module to convert electrical signals to optical signals or convert optical signals to electrical signals. The optical-electrical conversion module includes a cover fixed by glue on a circuit board above an optical signal emitting member and an optical signal receiving member. However, the glue located between the circuit board and the cover may be expanded when being solidified in a high temperature, and may cause some of the glue to flow towards the optical signal emitting member and the optical signal receiving member, which may result in damage done to the optical signal emitting member or the optical signal receiving member. In addition, air bubbles may be formed in the glue, and may cause a deviation of the cover when assembling the cover to the circuit board, which may negatively affect the optical coupling efficiency of the optical-electrical conversion module.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of an optical fiber connecting assembly including an optical-electrical conversion module.

FIG. 2 is a sectional view taken along line II-II of the optical-electrical module shown in FIG. 1

### DETAILED DESCRIPTION

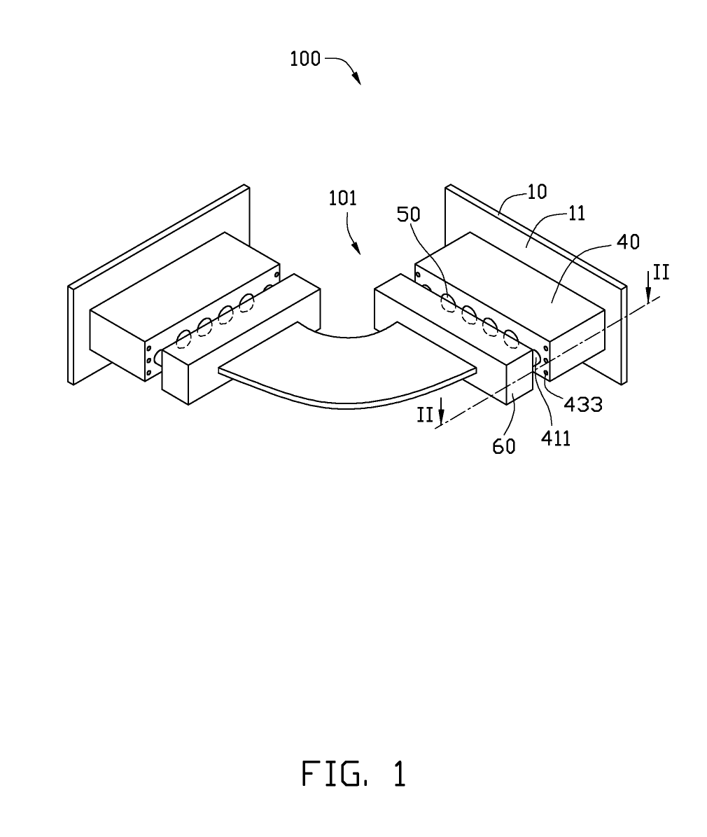

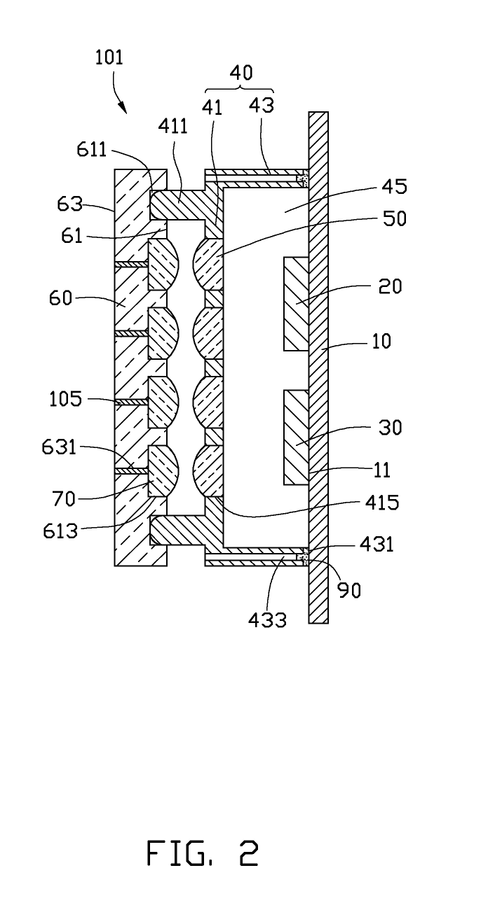

FIGS. 1 and 2 show an embodiment of an optical fiber connecting assembly 100. The optical fiber connecting assembly 100 includes a pair of optical-electrical conversion modules 101 and a plurality of optical fibers 105 connecting the pair of optical-electrical conversion modules 101. The optical-electrical conversion modules 101 are configured to convert optical signals to electrical signals or convert electrical signals to optical signals. The optical fibers 105 are configured to transmit optical signals.

The optical-electrical conversion module 101 includes a circuit board 10, an optical signal receiving member 20, an optical signal emitting member 30, a cover 40, at least two first lenses 50, a housing 60, and at least two second lenses 70. The optical signal receiving member 20, the optical signal emitting member 30, and the cover 40 are mounted on the circuit board 10. The cover 40 covers the optical signal receiving member 20 and the optical signal emitting member 30. The at least two first lenses 50 are mounted on the cover 40, and coupled with the optical signal receiving member 20 and the optical signal emitting member 30, respectively. The housing 60 is latched with the cover 40. The at least two second lenses 70 are mounted on the housing 60, and coupled with the at least two first lenses 50, respectively. Two distal ends of each optical fiber 105 are respectively inserted in the housing 60, and each optical fiber 105 couples with one corresponding second lenses 70.

The circuit board 10 includes a mounting surface 11 facing towards the cover 40. The mounting surface 11 is arranged with a plurality of circuits, to enable the optical signal receiving member 20 and the optical signal emitting member 30 to be mounted on the circuit board 10 to achieve their functions. The optical signal receiving member 20 and the optical signal emitting member 30 are mounted on the mounting surface 11 and arranged apart, and are electrically connected to the circuit on the circuit board 10. The optical signal receiving member 20 is configured to receive optical signals, and convert the optical signals to electrical signals. The optical signal emitting member 30 is configured to convert electrical signals to optical signals, and then emit the optical signals. In the illustrated embodiment, the optical signal receiving member 20 and the optical signal emitting member 30 are mounted on the circuit board 10 by welding. The optical signal receiving member 20 is a photodiode, and the optical signal emitting member 30 is a laser diode. In other embodiment, the optical signal receiving member 20 and the optical signal emitting member 30 can be mounted on the circuit board 10 by other means, such as, by pasting via electrical conductive glue, for example.

The cover 40 is fixed on the mounting surface 11 via a glue 90. In the illustrated embodiment, the glue 90 is UV glue. The cover 40 includes a base plate 41 and four sidewalls 43 extending from four sides or edges of the base plate 41. An end of the sidewalls 43 away from the base plate 41 is fixed to the mounting surface 11. The base plate 41 and the four sidewalls 43 define a receiving chamber 45 cooperatively, for receiving the optical signal receiving member 20 and the optical signal emitting member 30. A pair of positioning portions 411 perpendicularly protrude from the base plate 41 in an outwardly direction. A surface of the base plate 41 away from the sidewalls 43 defines at least two through holes 415. An end surface (a connecting surface 431) of the sidewalls 43 away from the base plate 41 defines a plurality of glue-overflow holes 433 extending towards the base plate 41, for receiving excessive glue. In the illustrated embodiment, the positioning portions 411 are located at opposite ends of the base plate 41. The number of the through holes 415 is four, and the through holes 415 are located between the pair of positioning portions 411 and are aligned with the positioning portions 411. The glue-overflow holes 433 are through holes, and the number of the glue-overflow holes 433 is six. The six glue-overflow holes 433 are located at each connecting portion of two adjacent sidewalls 43 and a middle portion of two parallel sidewalls 43. In the illustrated embodiment, the number of the positioning portions 411 can be one, three or more than three. The number of the glue-overflow holes 433 can be one or more, and the glue-overflow holes 433 can be blind holes. The base plate 41 can be in other shape, such as triangle trapezoid or other polygon shape, for example. Thus the number of the sidewalls 43 can be three or four according to the shape of the base plate 41. The shape of the connecting surface 431 can be changed to triangle, trapezoid or other polygon shape correspondingly.

In the illustrated embodiment, the number of the first lenses 50 is four. The four first lenses 50 are fixed within the four through holes 415, respectively. Two of the four first lenses 50 are coupled with the optical signal receiving member 20, and another two first lenses 50 are coupled with the optical signal emitting member 30. In other embodiments, the number of the first lenses 50 can be two, three, five, and so on, and the number of the through holes 415 is two, three, or five correspondingly.

The housing 60 is substantially cubic, and includes a first sidewall 61 facing towards the cover 40, and a second sidewall 63 opposite to the first sidewall 61. The first sidewall 61 defines a pair of positioning holes 611 corresponding to the positioning portions 411, and defines at least two receiving grooves 613 for receiving the at least two second lenses 70. The second sidewall 63 defines at least two receiving holes 631, for receiving the optical fibers 105. Each receiving hole 631 communicates with one corresponding receiving groove 613. In other embodiments, the number of the second lenses 70 can be two, three, five, and so on, and the number of the receiving groove 613 or the number of the receiving holes 631 is two, three, or five. Each end of the optical fibers 105 are inserted in the receiving holes 631 of the corresponding optical-electrical conversion module 101.

In assembly, the optical signal receiving member 20 and the optical signal emitting member 30 are mounted on the mounting surface 11 of the circuit board 10. The first lenses 50 are fixed within the through holes 415. The connecting surface 431 is dispensed with glue, and then the cover 40 covers the circuit board 10 with the connecting surface 431 bonding with the mounting surface 11. The second lenses 70 are received in the receiving grooves 613. The positioning portions 411 are inserted into the positioning holes 611, to enable the housing 60 to connect with the cover 40. The opposite ends of the optical fibers 105 are inserted into the receiving holes 631 of the corresponding optical-electrical conversion module 101.

In use, the optical signal emitting member 30 receives electrical signals from the circuit board 10, and then converts the electrical signals to optical signals. The optical signals are transmitted to the optical fibers 105 via the first lenses 50, and the second lenses 70. When the second lenses 70 receives optical signals from the optical fibers 105, and then the optical signals are transmitted to the optical signal receiving member 20 via the first lenses 50. The optical signal receiving member 20 receives the optical signals, and then convert the optical signals to electrical signals to the circuit board 10.

In other embodiments, the housing 60 and the second lenses 70 can be omitted. The optical fibers 105 can be inserted into the cover 40 coupling with the first lenses 50. The cover 40 may be changed to a suitable structure, accordingly.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An optical fiber connecting assembly, comprising:
a pair of optical-electrical conversion modules, each optical-electrical conversion module comprising:
a circuit board;
an optical signal receiving member mounted on the circuit board;
an optical signal emitting member mounted on the circuit board;
a cover covering the optical signal receiving member and the optical signal emitting member, and fixed with the circuit board with glue, a connecting surface of the cover facing towards the circuit board defining at least one glue-overflow hole, for receiving excessive glue;
at least two first lenses mounted on the cover, and coupling with the optical signal receiving member and the optical signal emitting member, respectively;
a plurality of optical fibers for connecting with the pair of optical-electrical conversion modules, each end of the optical fibers inserted into the cover and coupling with the at least two first lenses of one corresponding optical-electrical conversion module.

2. The optical fiber connecting assembly of claim 1, wherein the optical-electrical conversion module further comprises a housing and at least two second lenses, the housing is latched with the cover, the at least two second lenses are coupled with the at least two first lenses, each end of the optical fibers is inserted into the housing and coupled with the at least two second lenses of one corresponding optical-electrical conversion module.

3. The optical fiber connecting assembly of claim 1, wherein the cover comprises a base plate and a plurality of sidewalls protruding from the base plate in an outwardly direction, the connecting surface is located at an end of the sidewalls facing towards the circuit board.

4. The optical fiber connecting assembly of claim 3, wherein the connecting surface is polygon-shaped, the at least one glue-overflow hole is defined at each connecting portion of two adjacent sidewalls.

5. The optical fiber connecting assembly of claim 2, wherein at least one positioning portion is protruded from the base plate towards the housing, the housing defines at least one positioning hole corresponding to the positioning portion, the positioning portion is received in the positioning hole.

6. The optical fiber connecting assembly of claim 5, wherein a surface of the base plate facing towards the housing defines at least two through holes, the at least two first lenses are fixed within the at least two through holes.

7. The optical fiber connecting assembly of claim 6, wherein the housing comprises a first sidewall facing towards the cover, and a second sidewall opposite to the first sidewall, the positioning hole is defined at the first sidewall, the first sidewall further defines at least two receiving groove, the at least two second lenses are fixed within the at least two receiving groove.

8. The optical fiber connecting assembly of claim 7, wherein the second sidewall defines at least two receiving holes communicating with the corresponding at least two receiving groove, the end of the optical fibers are received in the receiving hole.

9. An optical-electrical conversion module comprising:
a circuit board;
an optical signal receiving member mounted on the circuit board;
an optical signal emitting member mounted on the circuit board;
a cover covering the optical signal receiving member and the optical signal emitting member, and fixed with the circuit board with glue, a connecting surface of the cover facing towards the circuit board defining at least one glue-overflow hole, for receiving excessive glue.

10. The optical-electrical conversion module of claim 9, wherein the optical-electrical conversion module further comprises a housing and at least two second lenses, the housing is latched with the cover, the at least two second lenses are coupled with the at least two first lenses.

11. The optical-electrical conversion module of claim 9, wherein the cover comprises a base plate and a plurality of sidewalls protruding from the base plate outwardly, the connecting surface is located at an end of the sidewalls facing towards the circuit board.

12. The optical-electrical conversion module of claim 11, wherein the connecting surface is polygon-shaped, the at least one glue-overflow hole is defined at each connecting portion of two adjacent sidewalls.

13. The optical-electrical conversion module of claim 10, wherein at least one positioning portion is protruded from the base plate towards the housing, the housing defines at least one positioning hole corresponding to the positioning portion, the positioning portion is received in the positioning hole.

14. The optical-electrical conversion module of claim 13, wherein a surface of the base plate towards the housing defines at least two through holes, the at least two first lenses are fixed within the at least two through holes.

15. The optical-electrical conversion module of claim 14, wherein the housing comprises a first sidewall facing towards the cover, and a second sidewall opposite to the first sidewall, the positioning hole is defined at the first sidewall, the first sidewall further defines at least two receiving groove, the at least two second lenses are fixed within the at least two receiving groove.
